(19) United States
(12) Patent Application Publication
(10) Pub. No.: US 2007/0008654 A1
(43) Pub. Date: Jan. 11, 2007

(54) Disk drive having improved disk drive components

(75) Inventors: Samuel W. Ho, Fremont, CA (US); Long V. Nguyen, Fremont, CA (US)

Correspondence Address: MICHAEL B. EINSCHLAG, ESQ., 25680 FERNHILL DRIVE, LOS ALTOS HILLS, CA, 94024, US

(73) Assignee: Riospring, Inc., Milpitas, CA (US)

(21) Appl. No.: 11/177,547

(22) Filed: Jul. 8, 2005

(51) Int. Cl. G11B 5/55

(52) U.S. Cl. 360/265.1

(57) ABSTRACT

One embodiment of the present invention is a head stack assembly of a disk drive, which head stack assembly includes: (a) a first contact disposed on a side of the head stack assembly, which first contact is adapted to contact a crash stop of the disk drive to stop the head stack assembly from moving in a first direction; and (b) a second contact disposed on the same side of the head stack assembly, which second contact is adapted to contact the crash stop to prevent the head stack assembly from moving in a second direction different from the first direction.

### TECHNICAL FIELD OF THE INVENTION

One or more embodiments of the present invention relate to a disk drive, and more particularly, to a head stack assembly and a head disk assembly of a disk drive.

### BACKGROUND OF THE INVENTION

Presently, typical prior art disk drives include: (a) one or more disks; (b) a head stack assembly (HSA) that rotates around an HSA pivot to move one or more read/write heads over surfaces of the one or more disks in performing read/write operations; (c) one or more ramp mechanisms adapted to guide loading/unloading of the one or more read/write heads on/off the one or more disks; and (d) two crash stops that are adapted to constrain certain movements of the one or more read/write heads.

FIG. 1 shows typical prior art head stack assembly 10 (prior art HSA 10), and FIGS. 2A and 2B show typical prior art head disk assembly 200 (prior art HDA 200) of a typical prior art disk drive that includes prior art HSA 10. As shown in FIG. 1, prior art HSA 10 includes outer diameter (OD) crash stop contact 11 and inner diameter (ID) crash stop contact 12, which crash stop contacts are disposed on opposite sides of prior art HSA 10. More specifically, crash stop contacts 11 and 12 are disposed on opposite sides of long axis 101 of prior art HSA 10. Long axis 101 is a plane perpendicular to the plane of FIG. 1 wherein long axis 101 includes a line extending through geometric centers of: (a) HSA pivot 13; (b) read/write head 16; and (c) coil 14 of prior art HSA 10. Typically, OD crash stop contact 11 and ID crash stop contact 12 are located on molded features of encapsulation 15 which surrounds coil 14 of prior art HSA 10. Crash stop contacts 11 and 12 are adapted to contact OD crash stop 21 and ID crash stop 22, respectively, of prior art HDA 200 (shown in FIGS. 2A and 2B) to constrain movement of read/write head 16.

As shown in FIG. 2A, whenever prior art HSA 10 rotates counter-clockwise to unload read/write head 16 from disk 25 onto ramp mechanism 23, OD crash stop 21 stops prior art HSA 10 from further rotation by contacting OD crash stop contact 11. As a result: (a) read/write head 16 does not move off ramp mechanism 23 and damage read/write head 16; and (b) encapsulation 15 (disposed around coil 14) does not collide with disk 25 and damage disk 25. Further, as shown in FIG. 2B, during read/write operations, whenever prior art HSA 10 rotates clockwise for read/write head 16 to access memory sections near an inner diameter of disk 25, ID crash stop 22 stops prior art HSA 10 from further rotation by contacting ID crash stop contact 12. As a result, read/write head 16 does not collide with, and damage itself or, motor 26.

For such typical prior art disk drives, OD crash stop 21 and ID crash stop 22 are used to avoid possible damage caused by both directions of movement of read/write head 16. However, using two crash stops incurs significant material and operating costs in manufacturing disk drives.

In light of the above, there is a need in the art for a disk drive or a disk drive component that solves one or more of the above-identified problems.

### SUMMARY OF THE INVENTION

One or more embodiments of the present invention solve one or more of the above-identified problems. In particular, one embodiment of the present invention is a head stack assembly of a disk drive, which head stack assembly comprises: (a) a first contact disposed on a side of the head stack assembly, which first contact is adapted to contact a crash stop of the disk drive to stop the head stack assembly from moving in a first direction; and (b) a second contact disposed on the same side of the head stack assembly, which second contact is adapted to contact the crash stop to prevent the head stack assembly from moving in a second direction different from the first direction.

### BRIEF DESCRIPTION OF THE DRAWING

FIG. 1 shows a prior art disk drive head stack assembly (HSA) that includes two crash stop contacts disposed on different sides of the HSA;

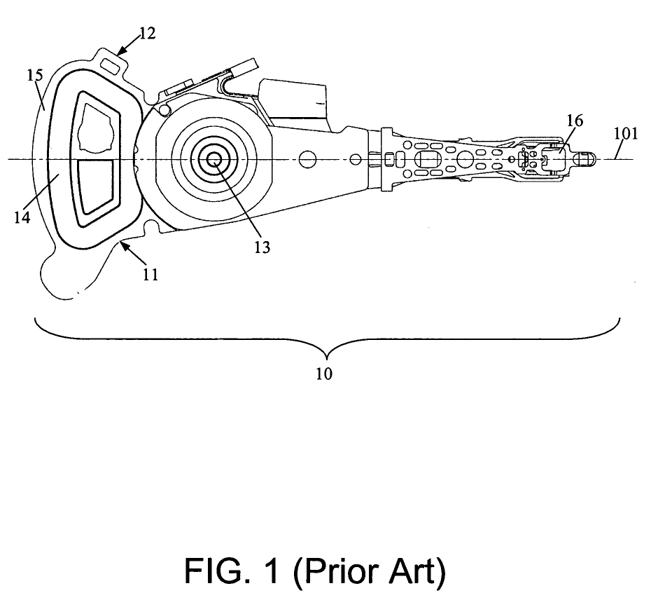

FIGS. 2A and 2B show a prior art disk drive head disk assembly (HDA) that includes two crash stops and the prior art HSA shown in FIG. 1;

FIG. 3 shows an HSA that is fabricated in accordance with one or more embodiments of the present invention and includes two crash stop contacts disposed on one side of the HSA;

FIGS. 4A and 4B show an HDA of a disk drive that is fabricated in accordance with one or more embodiments of the present invention wherein the HDA includes one crash stop and the HSA shown in FIG. 3;

FIG. 5 shows an HSA that is fabricated in accordance with one or more embodiments of the present invention, which HSA includes a coil disposed in an off-axis orientation;

FIGS. 6A and 6B show an HDA of a disk drive that is fabricated in accordance with one or more embodiments of the present invention wherein the HDA includes one crash stop and the HSA shown in FIG. 5; and

FIG. 7 shows an HSA that is fabricated in accordance with one or more embodiments of the present invention, which HSA includes a suspension disposed in an off-axis orientation.

### DETAILED DESCRIPTION

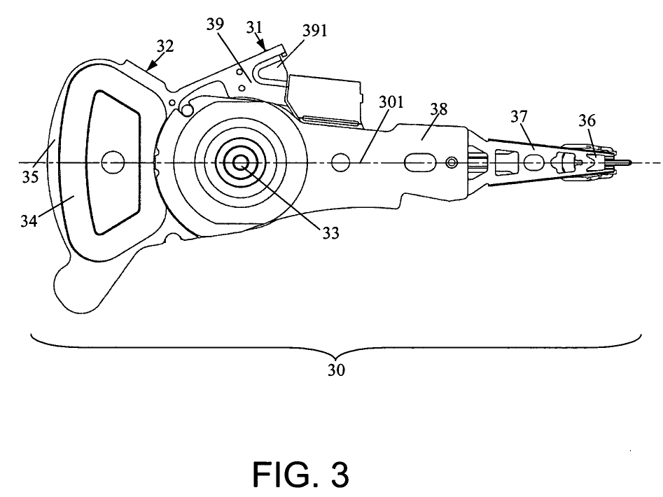

FIG. 3 shows head stack assembly 30 (HSA 30) that is fabricated in accordance with one or more embodiments of the present invention. As shown in FIG. 3, HSA 30 includes: (a) read/write head 36; (b) suspension 37 which is adapted to carry read/write head 36; (c) arm 38 which is adapted to support suspension 37; (d) pivot 33 which is connected to arm 38 and which is adapted to provide an axis about which HSA 30 can rotate; (e) coil 34 which is connected to arm 38 and which is adapted to provide an electromagnetic force for rotating HSA 30; and (f) encapsulation 35 which is adapted to encapsulate, support, and protect coil 34.

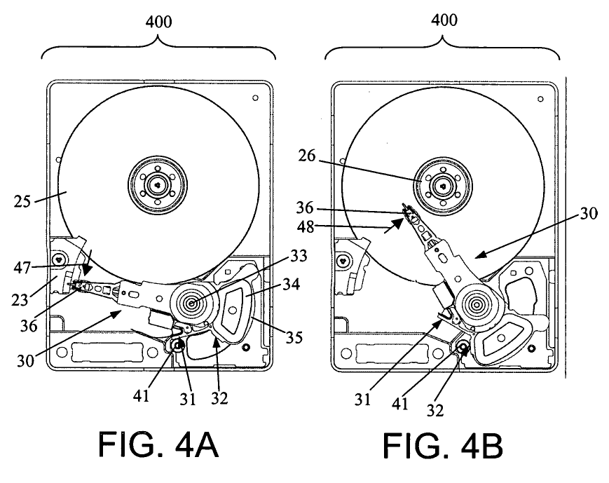

Further, as shown in FIG. 3, HSA 30 includes first contact 31 and second contact 32. In accordance with one or more such embodiments, first contact 31 and second contact 32 are disposed on encapsulation 35. The contacts are adapted to contact crash stop 41 (shown in FIG. 4) to limit movement of HSA 30 in a manner that will be further described below with reference to FIGS. 4A and 4B.

In accordance with one or more embodiments of the present invention, first contact 31 and second contact 32 are disposed on a side of HSA 30 (i.e., the same side). More specifically, as shown in FIG. 3, first contact 31 and second contact 32 are disposed on the same side of long axis 301 of HSA 30. In accordance with one or more embodiments of the present invention, long axis 301 is a plane perpendicular to the plane of FIG. 3 wherein long axis 301 includes a line extending through a geometric or mass center of pivot 33 and a geometric or mass center of read/write head 36. In other words, long axis 301 includes an axis (upon which HSA 30 rotates) provided by pivot 33 and a geometric center or mass center of read/write head 36. Further, in accordance with one or more further embodiments of the present invention, long axis 301 is a plane perpendicular to the plane of FIG. 3 wherein long axis 301 includes a line extending through a geometric or mass center of pivot 33 and a geometric or mass center of coil 34. In other words, long axis 301 includes the axis provided by pivot 33 and a geometric center or mass center of coil 34. Still further, in accordance with one or more further embodiments of the present invention, long axis 301 is a plane perpendicular to the plane of FIG. 3 wherein long axis 301 includes a line extending through a geometric or mass center of pivot 33 and a geometric or mass center of arm 38. In other words, long axis 301 includes the axis provided by pivot 33 and a geometric center or mass center of arm 38. Still further, in accordance with one or more further embodiments of the present invention, long axis 301 is a plane perpendicular to the plane of FIG. 3 wherein long axis 301 includes a line extending through a geometric or mass center of pivot 33 and a geometric or mass center of suspension 37. In other words, long axis 301 includes the axis provided by pivot 33 and a geometric center or mass center of suspension 37. Still further, in accordance with one or more further embodiments of the present invention, one or more of the above-identified long axes (i.e., planes) may be coincident.

FIGS. 4A and 4B show head disk assembly 400 (HDA 400) that is fabricated in accordance with one or more embodiments of the present invention. As shown in FIG. 4A, in accordance with one or more embodiments of the present invention, first contact 31 of HSA 30 is adapted to contact crash stop 41 to prevent further movement of HSA 30 in first direction 47. Further, as shown in FIG. 4A, in accordance with one or more such embodiments, first direction 47 corresponds to a rotational direction of HSA 30 whereby read/write head 36 moves away from disk 25 and onto ramp 23 of HDA 400. In accordance with one or more such embodiments, whenever HSA 30 rotates in first direction 47, after read/write head 16 moves onto ramp 23, first contact 31 contacts crash stop 41, thereby preventing HSA 30 from further rotation that: (a) would move read/write head 16 off ramp mechanism 23 and damage read/write head 16; or (b) would cause encapsulation 35 to collide with, and damage, disk 25.

As shown in FIG. 4B, in accordance with one or more embodiments of the present invention, second contact 32 is adapted to contact crash stop 41 to prevent further movement of HSA 30 in second direction 48. Further, as shown in FIG. 4B, in accordance with one or more such embodiments, second direction 48 corresponds to a rotational direction of HSA 30 whereby read/write head 36 moves towards an inner diameter of disk 25. In accordance with one or more such embodiments, whenever HSA 30 rotates in second direction 48 and whenever read/write head 16 reaches a predetermined limit near or at the inner diameter, second contact 32 contacts crash stop 41, thereby preventing HSA 30 from further rotation that would move read/write head 36 past the predetermined limit to collide with motor 26 and damage read/write head 36.

As one of ordinary skill in the art can readily appreciate, in any particular embodiment, the location, size, shape, and material of each of crash stop 41, first contact 31, and second contact 32 may be determined based on considerations such as, for example and without limitation, read/write head 36 movement range, inner diameter and outer diameter data positions of disk 25, shock absorption and force resistance of each of crash stop 41 and contacts 31 and 32, mechanical tolerances, HSA 30 balance, and overall HDA 400 layout. As is well known, different disk drive designs might have different requirements due to the above-mentioned considerations. The locations, sizes, shapes, and materials of crash stop 41, first contact 31, and second contact 32 for a particular disk drive design may be determined by one of ordinary skill in the art routinely and without undue experimentation utilizing any one of a number of methods that are well known to one of ordinary skill in the art such as, for example and without limitation, statistical analysis, finite element modeling, and computer simulation.

In accordance with one or more embodiments of the present invention, crash stop 41 includes a cylindrical stainless steel pin enclosed by a layer of rubber, which pin is affixed to a bottom of a base of HDA 400. Further, in accordance with one or more embodiments of the present invention, first contact 31 and second contact 32 each comprises a portion of a surface of encapsulation 35. Still further, in accordance with one or more further embodiments of the present invention, as shown in FIG. 3, first contact 31 and second contact 32 include portions of molded features of encapsulation 35. In accordance with one or more such embodiments, first contact 31 and second contact 32 include flat contact surfaces that are adapted to contact crash stop 41. Further, in accordance with one or more such embodiments, encapsulation 35 may be fabricated of a plastic material such as, for example and without limitation, liquid crystal polymer available from suppliers such as, for example and without limitation, Ticona (www.ticona.com) of Florence, Ky.; and encapsulation 35 may be fabricated using one or more processes that are well known to one of ordinary skill in the art. Still further, as shown in FIG. 3, in accordance with one or more embodiments of the present invention, encapsulation 35 includes molded feature 39 disposed between first contact 31 and arm 38, which molded feature 39 is adapted to provide support and reinforcement for first contact 31. In accordance with one or more such embodiments, molded feature 31 includes web feature 391, which web feature 391 has a reduced thickness from that of molded feature 39, and which web feature 391 is adapted to improve weight distribution and balance of HSA 30. However, the reduced thickness ought to be sufficient to support first contact 31 whenever first contact 31 contacts crash stop 41 (as shown in FIG.4A). The thickness of web feature 391 can be determined by one of ordinary skill in the art routinely and without undue experimentation utilizing any one of a number of methods that are well known to one of ordinary skill in the art such as, for example and without limitation finite element modeling and analysis.

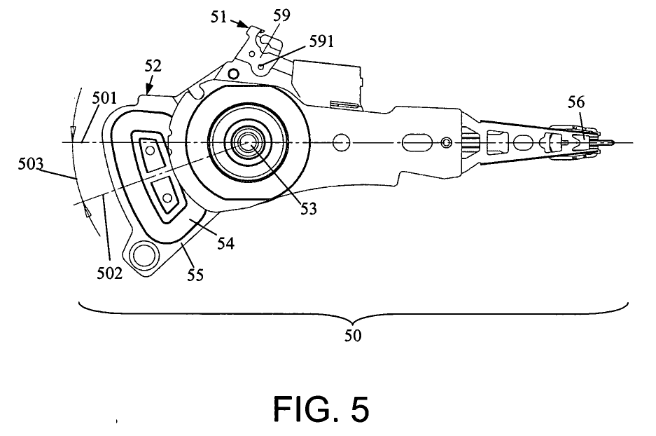

FIG. 5 shows head stack assembly 50 (HSA 50) that is fabricated in accordance with one or more embodiments of the present invention. As one can readily appreciate, HSA 50 includes components that are similar to those of HSA 30 shown in FIG. 3; however, as shown in FIG. 5, in accordance with one or more embodiments of the present invention, HSA 50 includes coil 54 which is oriented so that its center line, i.e., center line 502 (wherein center line 502 of coil 54 extends through geometric or mass centers of pivot 53 and coil 54) is rotated by angle 503 from long axis 501 of HSA 50. In accordance with one or more such embodiments, long axis 501 is a plane perpendicular to the plane of FIG. 5 wherein long axis 501 includes a line extending through a geometric or mass center of pivot 53 and a geometric or mass center of read/write head 56.

As one of ordinary skill in the art can readily appreciate, since first contact 51 and second contact 52 are disposed on the same side of HSA 50, providing molded features to support these contacts might cause material (and therefore the weight) of encapsulation 55 to be distributed asymmetrically with respect to long axis 501. Therefore, providing an orientation of coil 54 that is deflected from long axis 501 may provide a better weight distribution for HSA 50, and therefore provide better balance thereof.

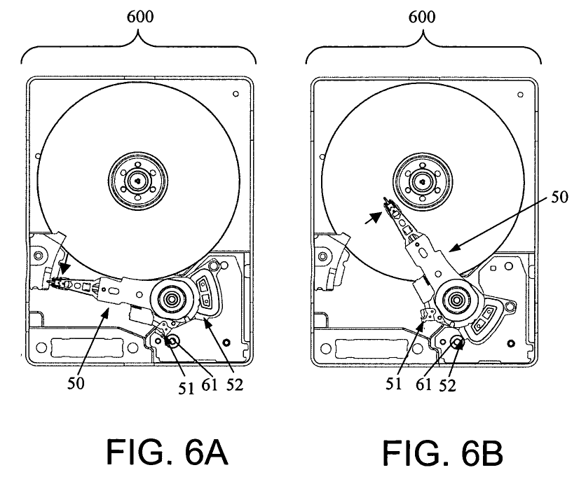

As one of ordinary skill in the art can readily appreciate, in any particular embodiment, angle 503 may be determined based on considerations such as, for example and without limitation, weight distribution of HSA 50 and layout and space available for HDA 600 (shown in FIGS. 6A and 6B). As is well known, different disk drive designs might have different requirements relative to the above-mentioned considerations. As such, angle 503 for a particular disk drive design may be determined by one of ordinary skill in the art routinely and without undue experimentation utilizing any one of a number of methods that are well known to one of ordinary skill in the art such as, for example and without limitation, statistical analysis and computer simulation. In accordance with one or more embodiments of the present invention, with possible errors in known manufacturing processes taken into account, angle 503 is at least 1 degree. Further, in accordance with one or more such embodiments, angle 503 is at least 5 degrees. As shown in FIG. 5, in accordance with one or more embodiments of the present invention, angle 503 is at least 20 degrees.

In accordance with one or more embodiments of the present invention, HSA 50 includes molded feature 59 that is adapted to support first contact 51. In accordance with one or more such embodiments, molded feature 59 includes cavity 591 or a plurality of cavities that are used to reduce the weight of molded feature 59, and thereby, help improve the balance of HSA 50.

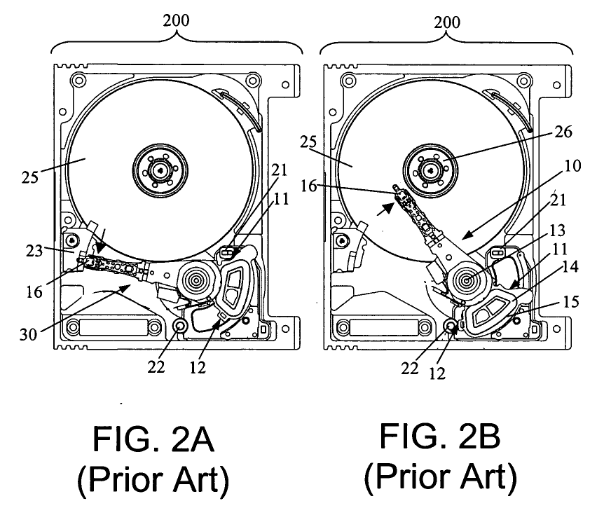

FIGS. 6A and 6B show head disk assembly 600 (HDA 600) that is fabricated in accordance with one or more embodiments of the present invention and which includes HSA 50 shown in FIG. 5. In accordance with one or more embodiments of the present invention, HSA 50, first contact 51, second contact 52, and crash stop 61 operate in a manner similar to the manner in which HSA 30, first contact 31, second contact 32, and crash stop 41 in HDA 400, (shown in FIGS. 4A and 4B and described above) operate. Nevertheless, advantageously as a result of angle 503, crash stop 61 is better located “layout-wise” in HDA 600 (shown in FIGS. 6A and 6B) when compared with (a) crash stop 41 in HDA 400 (shown in FIGS. 4A and 4B), and (b) crash stop 22 in prior art HDA 200 (shown in FIGS. 2A and 2B). For example and without limitation, this is due to having more space around crash stop 61 so that fabrication of HDA 600 may be simplified.

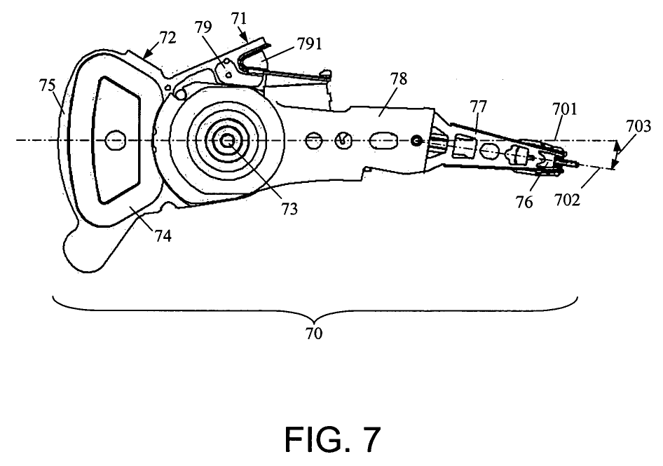

FIG. 7 shows head stack assembly 70 (HSA 70) that is fabricated in accordance with one or more embodiments of the present invention. As one can readily appreciate, HSA 70 includes components that are similar to those of HSA 30 shown in FIG. 3; however, as shown in FIG. 7, in accordance with one or more embodiments of the present invention, HSA 70 includes suspension 77 which is oriented so that its center line, i.e., center line 702 (wherein center line 702 of suspension 77 extends through geometric or mass centers of read/write head 76 and suspension 77) is rotated by angle 703 from long axis 701 of HSA 70. In accordance with one or more embodiments of the present invention, long axis 701 is a plane perpendicular to the plane of FIG. 7 wherein long axis 701 includes a line extending through a geometric or mass center of pivot 73 and a geometric or mass center of coil 74. Further, in accordance with one or more further embodiments of the present invention, long axis 701 is a plane perpendicular to the plane of FIG. 7 wherein long axis 701 includes a line extending through a geometric or mass center of pivot 73 and a geometric or mass center of read/write head 76.

As a result, as one of ordinary skill in the art can readily appreciate, in an HDA that utilizes HSA 70 (and is fabricated in accordance with one or more embodiments of the present invention), arm 78 of HSA 70 can rotate further away from a disk of the HDA than arm 38 of HSA 30 in HDA 400 (shown in FIG. 4A) can rotate without moving read/write head 76 past a ramp of the HDA (that utilizes HSA 70)—assuming the same crash stop positions. As a result, molded feature 79 of HDA 70 has a smaller size than molded feature 39 of HSA 30 (shown in FIG. 3). Hence, fabricating HSA 70 may require less material for encapsulation 75, and HSA 70 may have improved balance. Further, angle 703 may enable read/write head 76 to have better alignment with data tracks of the disk of the HDA (that utilizes HSA 70). However, given the same crash stop positions, a molded feature that supports second contact 72 of HSA 70 may have a larger size than a molded feature of encapsulation 35 that supports second contact 32 of HSA 30. An appropriate magnitude of angle 703, an appropriate crash stop position, and appropriate sizes of molded features may be determined by one of ordinary skill in the art routinely and without undue experimentation utilizing any one of a number of methods that are well known to one of ordinary skill in the art such as, for example and without limitation, statistical analysis and computer simulation. In accordance with one or more embodiments of the present invention, with possible errors in known manufacturing processes taken into account, angle 703 is at least 1 degree. Further, in accordance with one or more such embodiments, angle 703 is at least 5 degrees. As shown in FIG. 7, in accordance with one or more such embodiments, angle 703 is at least 9 degrees.

The embodiments of the present invention described above are exemplary. Many changes and modifications may be made to the disclosure recited above, while remaining within the scope of the invention. The scope of the invention should, therefore, be determined not with reference to the above description, but instead should be determined with reference to the appended claims along with their full scope of equivalents.

What is claimed is:

1. A head stack assembly of a disk drive, the head stack assembly comprising:
a first contact disposed on a side of the head stack assembly, which first contact is adapted to contact a crash stop of the disk drive to stop the head stack assembly from moving in a first direction; and
a second contact disposed on the same side of the head stack assembly, which second contact is adapted to contact the crash stop to prevent the head stack assembly from moving in a second direction different from the first direction.

2. The head stack assembly of claim 1 wherein movement in the first direction causes a head of the head stack assembly to move away from a disk of the disk drive.

3. The head stack assembly of claim 1 wherein movement in the second direction causes a head of the head stack assembly to move towards an inner diameter of a disk of the disk drive.

4. The head stack assembly of claim 1 wherein the first contact is a portion of an encapsulation of the head stack assembly.

5. The head stack assembly of claim 1 wherein the first contact comprises a surface of an encapsulation of the head stack assembly.

6. The head stack assembly of claim 1 wherein the first contact is a portion of a molded feature of an encapsulation of the head stack assembly.

7. The head stack assembly of claim 6 wherein the molded feature comprises a web feature having a thickness smaller than an average thickness of the molded feature.

8. The head stack assembly of claim 6 wherein the molded feature comprises one or more cavities.

9. The head stack assembly of claim 1 further comprising:
a pivot which is adapted to provide an axis upon which the head stack assembly can rotate; and
a coil which is adapted to provide an electromagnetic force to cause the head stack assembly to rotate;
wherein the first contact and the second contact are disposed on the same side of a plane that includes the axis and a geometric center or mass center of the coil.

10. The head stack assembly of claim 9 further comprising a read/write head wherein the plane is disposed at an angle with respect to another plane that includes the axis and a geometric or mass center of the read/write head.

11. The head stack assembly of claim 10 wherein the angle is at least 1 degree.

12. The head stack assembly of claim 10 wherein the angle is at least 5 degrees.

13. The head stack assembly of claim 10 wherein the angle is at least 20 degrees.

14. The head stack assembly of claim 1 further comprising:
a pivot which is adapted to provide an axis about which the head stack assembly can rotate;
an arm, connected to the pivot, that is adapted to support a suspension that carries a head of the head stack assembly;
wherein the first contact and the second contact are disposed on the same side of a plane that includes the axis and a geometric or mass center of the arm.

15. The head stack assembly of claim 1 further comprising:
a pivot which is adapted to provide an axis about which the head stack assembly can rotate;
a read/write head;
wherein the first contact and the second contact are disposed on the same side of a plane that includes the axis and a geometric or mass center of the read/write head.

16. A disk drive comprising:
a head stack assembly that comprises a first contact and a second contact; and
a crash stop which is adapted to: (a) stop the head stack assembly from moving in a first direction upon contacting the first contact; and (b) stop the head stack assembly from moving in a second, different direction upon contacting the second contact.

17. The disk drive of claim 16 wherein the first contact and the second contact are disposed on a same side of the head stack assembly.

18. A head stack assembly of a disk drive, the head stack assembly comprising:
a suspension which is adapted to carry a read/write head;
a pivot which is adapted to provide an axis upon which the head stack assembly can rotate;
a coil which is adapted to provide an electromagnetic force to cause the head stack assembly to rotate;
wherein a center line of the suspension is disposed at an angle with respect to a plane that includes the axis and a geometric center or mass center of the coil.

19. The head stack assembly of claim 18 wherein the angle is at least 1 degree.

20. The head stack assembly of claim 18 wherein the angle is at least 5 degrees.

21. The head stack assembly of claim 18 wherein the angle is at least 9 degrees.
